(19) United States
(12) Patent Application Publication
(10) Pub. No.: US 2003/0138598 A1
(43) Pub. Date: Jul. 24, 2003

(54) Foldable printable substrate

(75) Inventor: Timothy W. Rawlings, Waynesville, OH (US)

Correspondence Address: DOUGLAS S. FOOTE, NCR CORPORATION, 1700 S. PATTERSON BLVD. WHQ5E, WHO-5E, DAYTON, OH, 45479, US

(73) Assignee: NCR Corporation

(21) Appl. No.: 10/051,352

(22) Filed: Jan. 18, 2002

(51) Int. Cl. B32B 3/10

(52) U.S. Cl. 428/131; 428/43

(57) ABSTRACT

A printable substrate with a print medium such as bond paper, thermal paper and card stock, is provided with one or more fold lines comprising intermittent sections of microperforations and non-perforated sections. The fold line defines the location for folding by weakening the print medium without causing the separation of the print medium. The substrate may be printed either before or after folding.

### FIELD OF THE INVENTION

The invention relates to printable substrates which are to be folded without separation along a fold line.

### BACKGROUND OF THE INVENTION

Substrates that run through printers such as laser ink jet printers and copiers often incorporate perforations. There are perforations which aid in tearing the substrates into sections and there are perforations used to weaken a sheet to facilitate folding. Standard perforations visible to the naked eye have extraneous fibers and the cuts and ties have sharp edges that nest into underlying substrates when stacked or catch on paper handling equipment as the substrate travels along its path through a printer. This can cause double feeding of substrates into the printers and copiers and also jamming of the paper handlers. The use of microperforations has been shown to minimize if not eliminate feed problems within printers and copiers. The small cuts and ties do not create edges that nest or catch on the paper handling equipment.

Microperforations weaken a substrate and are generally acceptable for providing a line of separation in a substrate. The conventional use of microperforations weakens substrates too much to provide fold lines. The weakened substrate will typically partially separate or fall apart when additionally weakened by folding or will separate upon use after folding. U.S. Pat. No. 5,136,130 states at col. 2, lines 27-35 that: “These microperforations formed a weakened line across a sheet which was greatly weakened by a fold along the perforations, so that the sheets required less than 1 or 2 kilograms of force for separation and these weakened sheets did not print reliably following folding and unfolding”.

### SUMMARY OF THE INVENTION

It is desirable to provide a printable substrate for passing through a printer or a copier which may be readily folded and subsequently unfolded at a fold line defined by microperforations, either before or after being feed through a printer or copier, without tearing at the fold line. There is provided by this invention a printable substrate for passing through a printer or copier comprising a print medium adapted to print desired indicia thereon and one or more fold lines within said print medium. The one or more fold lines comprises a discontinuous line of both microperforations extending into said print medium and intermittent non-perforated sections that extend along the length or width of the print medium. The fold lines define locations where the print medium can be easily folded. Folding, as defined herein, comprises bending a substrate from 90 degrees to 180 degrees, where bending a substrate 180 degrees is equivalent to overlapping one portion of the substrate with another to lie flat. The fold lines permit the print medium to be folded and unfolded at least once along their length without separation either before or after printing.

The substrate used in the present invention may be in the form of continuous rolls, separate sheets, continuous fanfold sheets or laminates such as label laminates or forms having labels integrated therein. The label laminates and integrated forms typically comprise a sheet of print medium, adhesive and a base sheet. The print medium of the substrate may be comprised of various materials including paper and plastic materials (acrylic sheets). The print medium can have a thickness ranging from about 3 to 20 mils with a thickness of 6 to 10 mils being preferred and can include onion skin paper, calendared papers, supercalendared papers, card stock, thermal paper and bond paper.

Substrates in the form of continuous rolls can have a width consistent with cash register receipts up to widths consistent with newspaper sheets. The separate paper sheets can also vary widely in size with conventional sizes such as letter size, A4 and legal size being most preferred. The continuous fanfold paper can vary widely in width from label sheets to tractor fed plotter paper.

The print medium may have preprinted indicia thereon such as those used on conventional business forms. The print medium has one or more fold lines which defines locations where the print medium that can be easily folded. The conventional separate sheets (letter size, A4 and legal size) typically have from 1 to 3 fold lines to reduce the size of the substrate to one which will fit within a conventional legal size envelope (4.25″ w×9.5″ l). The fold lines can extend along the length or width of the print medium.

The one or more fold lines are comprised of microperforations extending through or substantially through the thickness of said print medium. The fold lines also comprise intermittent non-perforated sections. The microperforations suitable for use in this invention comprise cuts, including slits or round holes, having a maximum dimension of less than 0.75 mm. Preferably, the microperforations have a maximum dimension of less than 0.50 mm and most preferably, the maximum dimension is in the range of 0.2 mm to 0.4 mm. Perforations of this size are effective and preferably, not readily visible to allow printing on the fold line.

The ties between the microperforations are preferably less than 0.5 mm in length and most preferably in the range of 0.2 mm to 0.4 mm. Microperforations having ties and cuts (slits/holes) with the preferred dimensions typically have at least about 35 cuts and 35 ties per linear inch, although many more may be present. Microperforations having 50-70 cuts and 50-70 ties per inch are common.

The perforations can extend all the way through the print medium or they can extend substantially through the print medium i.e., about 40 to 95% of the thickness of said print medium.

The microperforations do not extend across the whole length of the fold line. The fold line is shared with intermittent non-perforated sections. The extent to which non-perforated sections are present is dependent on the strength desired of the fold line. It is contemplated from 10 to 80% of the fold line can comprise intermittent non-perforated portions, depending on the strength of the print medium. In amounts less than 10%, the non-perforated portions will either be so short or so infrequent as to provide little additional support for the print medium. If over 80% of the fold line comprises non-perforated portions, the microperforations will be so finely dispersed and short in length as to provide little contribution to the weakening of the print medium to define a fold line. The non-perforated portions preferably form from 40 to 60% of the fold line for conventional bond and thermal paper sheets. This range will be different for different print media. For example, laminates such as label laminates will require more microperforations to define a fold line.

The intermittent non-perforated sections preferably vary in length from about 1 mm to 5 mm, preferably about 2.5 mm, but can have a length which is up to 20% of the total width of the print medium.

The fold lines within the print medium can be produced by methods consistent with conventional techniques, i.e., by microperforating the print medium with a straight or circular cutting blade having a number of uniform nicks in the cutting edge. These nicks provide protrusions which pierce the print medium. To provide for the intermittent non-perforated sections, the nicks can be spaced apart to provide the desired length of the non-perforated portion (from 1 to 5 mm). Alternatively, various segments of the fold lines can be impacted by a short blade providing the desired microperforations.

### BRIEF DESCRIPTION OF THE DRAWING

FIG. 1 is a perspective view of a printable substrate of this invention.

FIG. 2 is a magnified view of a fold line in the printable substrate of FIG. 1.

FIG. 3 is a magnified view of another fold line in the printable substrate of FIG. 1.

FIG. 4 is another magnified view of a fold line in the printable substrate of FIG. 1.

### DETAILED DESCRIPTION

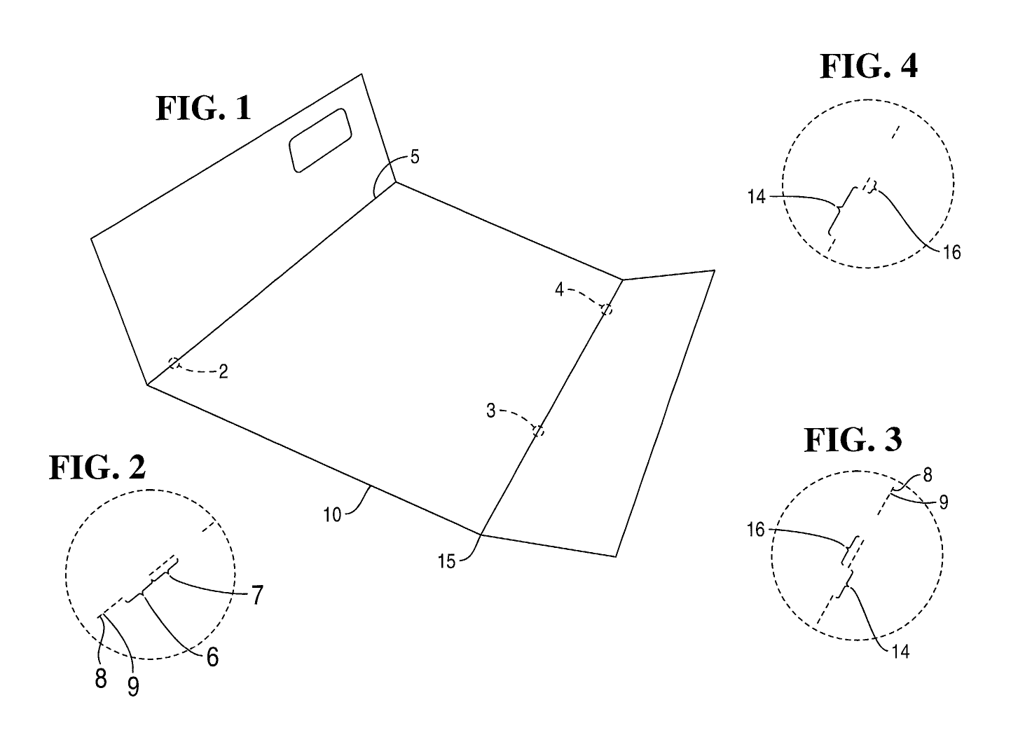

FIG. 1 illustrates a business form 10 consistent with the present invention having fold lines 5 and 15. FIG. 2 is a magnified view of fold line 5 showing micropreforations 8 and ties 9. This magnified view shows that fold line 5 comprises non-perforated sections 6 and microperforated sections 7 of equal length both alternating in continuous fashion along the length of fold line 5. FIGS. 3 and 4 are magnified views of fold line 15 showing microperforations 8 and ties 9. As shown by FIGS. 3 and 4, fold line 15 comprises non-perforated sections 14 of varying length across fold line 15 with longer sections at the edges than at the center of fold line 15 with microperforated sections 16 therebetween. In preferred embodiments, these non-perforated sections are aligned with feed rollers of the printer so as to avoid separation of the print medium during printing.

The entire disclosure of all applications, patents and publications cited above is hereby incorporated by reference. From the foregoing description, one skilled in the art can easily ascertain the essential characteristics of this invention and, without departing from the spirit and scope thereof can various changes and modifications of the invention to adapt it to various usages and conditions.

What is claimed is:

1. A printable substrate for passing through a printer or copier comprising a print medium adapted to print desired indicia thereon and
one or more fold lines within said print medium, each of which extends along the length or width of said print medium and defines a location where the print medium can be folded;
wherein said one or more fold lines comprises of a) a discontinuous line of microperforations extending through or substantially through the thickness of said print medium and b) intermittent non-perforated sections,
wherein said fold lines permit the print medium to be folded and unfolded at least once along their length before printing or after printing without separation of the print medium along the fold lines.

2. A printable substrate as in claim 1, in the form of a separate sheet, continuous fanfold sheets, a continuous roll, or a laminate selected from the group consisting of label laminates, and forms with labels integrated therein.

3. A printable substrate as in claim 2, wherein the print medium is selected from the group consisting of onion-skin papers, calendared papers, supercalendared papers, card stock, thermal papers, bond papers and acrylic sheets.

4. A printable substrate as in claim 3, which is a form with removable labels integrated therein having preprinted indicia on said print medium.

5. A printable substrate as in claim 1, which requires more than 2 kilograms of force to separate the print medium along its fold line.

6. A printable substrate as in claim 1, wherein the microperforations penetrate through 40 to 100% of the thickness of said print medium.

7. A printable substrate as in claim 1, having two or more fold lines.

8. A printable substrate as in claim 1, wherein the microperforations have a maximum dimension in the range 0.2 mm to 0.4 mm and the ties between these microperforations are less than 0.5 mm in length.

9. A printable substrate as in claim 1, wherein the non-perforated sections comprise from 10 to 80% of the fold line.

10. A printable substrate as in claim 1, wherein the non-perforated sections comprise from 40 to 60% of the fold line.

11. A printable substrate as in claim 10, wherein the non-perforated sections have a length of from 1 to 5 mm.

12. A printed substrate as in claim 11, wherein the non-perforated sections have a length of up to 20% of the width of said print medium.

13. A printable substrate as in claim 12, wherein the non-perforated sections are of equal length and the sections of microperforations are of equal length.

14. A printable substrate as in claim 1, wherein the non-perforated sections on the fold line are of different lengths and are spaced unevenly along the fold line.

15. A printable substrate as in the claim 1, wherein the non-perforated sections are positioned on the fold line so as to be aligned with feed rollers of a preselected printer.

16. A printable substrate as in claim 15, wherein non-perforated sections of from 2 cm to 10 cm are positioned on the fold line within 1 to 3 inches of each edge of said printer medium so as to be aligned with the print rollers of a printer.

17. A printable substrate as in claim 1, which requires more than 5 kilograms of force to separate the print medium along its fold line.

18. A printable substrate for passing through a printer or copier comprising a print medium adapted to print desired indicia thereon and
one or more fold lines within said print medium, each of which extends along the length or width of said print medium and defines a location where the print medium can be folded;
wherein said one or more fold lines comprises of a) a discontinuous line of microperforations extending through or substantially through the thickness of said print medium and b) intermittent non-perforated sections,
wherein said fold lines permit the print medium to be folded and unfolded at least once along their length before printing or after printing without separation of the print medium along the fold lines,
wherein more than 5 kilograms of force is required to separate the print medium along said fold lines.

19. A printable substrate as in claim 18, which is a form with removable labels integrated therein having preprinted indicia on said print medium.
